(19) United States
(12) Patent Application Publication
(10) Pub. No.: US 2006/0176273 A1
(43) Pub. Date: Aug. 10, 2006

(54) Ergonomic mouse

(76) Inventor: Douglas Bonforte Wolfe, Colorado Springs, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 11/349,751

(22) Filed: Feb. 8, 2006

Related U.S. Application Data
(60) Provisional application No. 60/651,672, filed on Feb. 10, 2005.

(51) Int. Cl. G09G 5/00

(52) U.S. Cl. 345/156

(57) ABSTRACT

An ergonomic input controller includes a pedestal that is in contact with a work surface, such as a desk or an equipment operation panel. A stem is attached atop the pedestal and a grip body is rotatably attached atop the stem at an input housing. An input detector is incorporated into the grip body and is in communication with the input housing. The input detector provides signals regarding grip body movement about the stem. A z-axis controller permits the user to manipulate three dimensional drawings. A maintaining device is attached prevents inadvertent movement of the grip body and holds the grip body in its last used position. An encoder is in communication with and receives signals from the input detector. The encoder provides control signals for output to the computer, game, data input device or industrial controller.

### RELATED APPLICATIONS

The present invention claims priority on provisional patent application, Ser. No. 60/651,672, filed on Feb. 10, 2005, entitled “Ergonomic Mouse” and is hereby incorporated by reference.

### FIELD OF THE INVENTION

The present invention relates generally to the field of cursor controls, data input devices and industrial controllers and more particularly to an ergonomic device for communicating positional and controlling inputs to a computing device through multi-dimensional angular displacement.

### BACKGROUND OF THE INVENTION

Controllers for electronic and electromechanical systems are found in many parts of our daily lives. Such controllers include computer mice, data input devices, game controllers and industrial controllers. Several shortcomings are evident with these devices.

First, conventional computer mice require a large operating space. These mice use a mechanical wheel, ball or light source to track physical movement of the mouse along a work surface. Such mice convert the user's hand movements into movement of a cursor on a computer screen. It is required that the mouse be physically moved across the work surface, thus a large area is required.

Second, conventional mice often do not track consistently across the user's work space. A mouse pad is often employed to aid the mouse in tracking more consistently, but this is a bandage, and not a true solution to the problem.

Third, if the mouse skips, sticks, or has other tracking problems, the mouse can run off the edge of the mouse pad or the user's work surface before the cursor is in the desired position. This forces the user to reposition the mouse, that is, to pick it up and place it back on the mouse pad to continue the motion. Alternatively, the user can continue moving the mouse off of the mouse pad or outside the designated tracking area potentially placing the user's arm, wrist or hand in harmful/stressful positions. Additionally, repositioning the mouse is very disruptive to the task at hand and the resulting loss of congruence in motion may have detrimental effect on user's desired outcome.

Fourth, normal mouse operation is stressful to the users wrist, arm, elbow and shoulders unless operated within tight specific guidelines which are hard adhere to based upon conventional mouse design. A user typically uses a mouse with his or her forearm in a pronation orientation. The hand lying on a typical mouse translates the mouse forward, backward, left or right. To accomplish this type of movement the wrist must radial and ulnarly deviate (corresponding to a left or right motion respectively) from the its radially axis and reposition the user's forearm to provide for a forward or reward translation. The movement adds stress to the writs as decreases the degree of accuracy with which a user can manipulate the mouse.

Other types of controls, commonly called joysticks, resemble an aircraft control stick. These sticks provide similar input controls as a conventional mouse, but have a major drawback when used for controlling a computer: they return to center automatically when released. This is a helpful attribute for an aircraft or similar game, but is tremendously unproductive for most common computer tasks. Thus, the user would need to reacquire the cursor and move it back to the last position before continuing the desired action. The user would not be able to release the control, perform a word processing task, and continue with the cursor where he left off.

Trackballs are sometimes used. They take a minimum of desk space but require an stressful thumb movement to reposition the cursor, particularly in the up and down direction on a computer screen.

Thus, what is desired is a computer mouse, controller or input device that solves the aforementioned problems and does not require the user to assume stressful positions.

### SUMMARY OF INVENTION

An ergonomic input controller includes a pedestal that is in contact with or incorporated in a work surface, such as a desk or an equipment operation panel. A stem is attached atop the pedestal and an ergonomically shaped grip body is rotatably attached atop the stem at an input housing. An input detector is coupled to the grip body and is in communication with the input housing. The input detector provides signals regarding angular displacement of the grip body about the stem. In one embodiment of the present invention a z-axis controller permits the user to manipulate three dimensional drawings. The input housing further comprises a maintaining device capable of preventing inadvertent movement of the grip body and to hold the grip body in its last used position. An encoder is in communication with and receives signals from the input detector. The encoder provides control signals for output to the computer, game, data input device, car navigation system, side-view mirror adjustment, or industrial controller. The controller has the usefulness of a common computer mouse and the action of a joystick, but without the shortcomings of each.

The foregoing and other features, utilities and advantages of the invention will be apparent from the following more particular description of an embodiment of the invention as illustrated in the accompanying drawings.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a left side view of an ergonomic controller, in accordance with the present invention;

FIG. 2 is a front view of the ergonomic controller, in accordance with the present invention;

FIG. 3 is a back view of the ergonomic controller, in accordance with the present invention;

FIGS. 4a-4c are front views of the controller to illustrate the operation of the controller in the x-axis, according to the present invention;

FIGS. 5a-5c are left side views of the controller to illustrate the operation of the controller in the y-axis, according to the present invention;

FIGS. 6a-6c are left side views of the controller to illustrate the adjustment of the stem upon the pedestal, according to the present invention; and

FIGS. 7a-7c are front views of the controller to illustrate the adjustment of the stem upon the pedestal, according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein

### DETAILED DESCRIPTION OF THE DRAWINGS

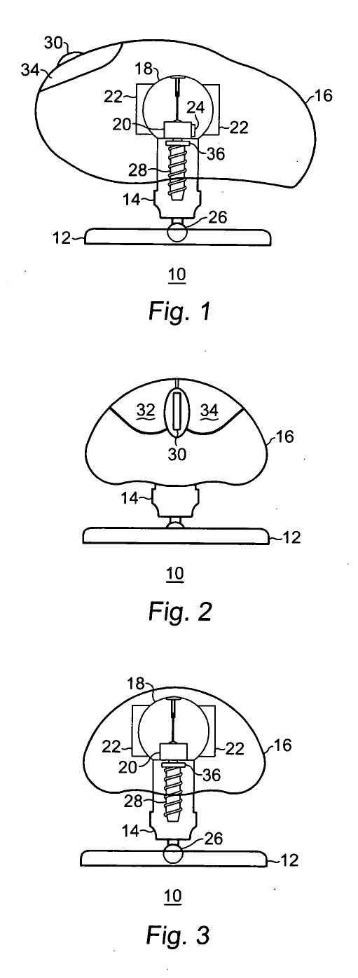

In summary, the invention is an ergonomic controller for computers, games, data input devices and industrial controllers. FIGS. 1-3 show side, front and back views of the ergonomic input controller 10. The controller 10 includes a pedestal 12 that is in contact with a work surface, such as a desk or an equipment operation panel. In one embodiment, a stem 14 is attached atop the pedestal 12. A grip body 16 is gimbaled atop the stem 14. Rotation is enabled with an input housing 18 having at least a 2 degree of freedom of movement mechanism with intersecting axes or the grip body 16 and stem 14. Such mechanisms may include a ball, a pair of arctuate linkages that can engage the grip body 16, or a shaft therefrom, and provide rotational guidance to the grip body 16. Alternatively, a gimbal assembly or CV joint, can provide the degree of movement necessary for grip body 16 motion. The gimbal assembly can be counterweighted to balance the grip body 16. A dome or hemispherical support can also be incorporated to control the movement of the grip body 16. Where a ball is attached to the grip body 16 and is used to provide rotational movement, the ball can be supported on a number of spring-loaded rollers.

In another embodiment, there is no stem 14 between the pedestal 12 and the grip body 16. An input housing 18 is attached directly between the pedestal 12 and the grip body 16.

In another embodiment, the parts of the device between the grip body 16 and the pedestal 12 may be inverted, for ease of manufacturing or other factors.

An input detector 20 is incorporated into the grip body 16 and is in communication with the input housing 18 or similar mechanism. The input detector 20 provides signals regarding grip body 16 position and movement about the input housing 18. If a pair of arctuate linkages are used, the linkages can provide input to a pair of position sensors, one for each the x- and y-axes. Where a ball is supported on a number of spring-loaded rollers, the rollers can provide input to the position sensors.

The input detector 20 may be a foveated or non-linear input device, where rotation with a predetermined range of a neutral point results in a very fine motion of the cursor. Rotation of the grip body 16 beyond that predetermined range results in a normal cursor motion. In another embodiment, the neutral point resets itself to the current grip body 16 position after a predetermined period of inactivity, or if selected by the user. Thus, the fine cursor motion may be placed where the user desires.

A position maintainer 22 is attached at the input housing 18 to prevent inadvertent movement of the grip body 16 and to hold the grip body 16 in its last used position. The position maintainer 22 may be a ball with a plurality of dimples and a number of spring-loaded plungers to alternately engage and disengage the dimples and thereby prevent the grip body 16 from moving under its own weight. Alternatively, the ball may be smooth, but with a surface having just enough static friction between itself and the plungers to prevent the grip body 16 from moving under it own weight.

An encoder 24 is in communication with and receives signals from the input detector 20. The encoder 24 provides control signals for output to the computer, game, data input device or industrial controller.

In one embodiment, the stem 14 is adjustably attached atop the pedestal 12. The adjustment mechanism permits the user to adjust the stem 14 to the desired angle for the most comfort and effective use. A ball joint 26 may be employed to provide 360-degree adjustability for the stem 14. In addition, the stem 14 can include a threaded adjuster 28. The threaded adjuster 28 permits the user to adjust the length of the stem 14, and thus the height of the grip body 16 over the pedestal 12. The adjustment mechanism can be a threaded joint, such as a worm screw, or other type of easily adjustable joint. A locking ring can bind the threaded joint 28 of the stem 14 at the desired length. In one embodiment, the stem 14 is adjustable down to zero length for individuals who prefer a low hand position and grip body 16.

Where the controller 10 is used as a computer mouse, the grip body 16 includes a plurality of control buttons as are commonly found on computer mice, such as a scroll controller 30 and a plurality of input and selection buttons 32, 34. The mouse 10 provides input corresponding to the planar x- and y-axes, as found on a computer screen. Angular displacements of the grip body as attached to the input housing 18 are converted to planar displacements of the cursor as interpreted and displayed on a convention computer screen. In one embodiment of the present invention the grip body 16 is centered at a reference or datum position that corresponds to the center of the computer display. A full-range angular displacement in the dorsal or palmar direction of the grip body will produce a first translational displacement of the cursor on the computer screen while a full-range radial displacement of the grip body 16 and the corresponding angular deflection of the input housing 18 will produce a second translational displacement of the cursor perpendicular to the first translational displacement.

In another embodiment, the controller 10 further includes a z-axis controller 36 that is incorporated into the grip body 16 enabling a user to manipulate the position of a cursor in three dimensional space. The user engages the z-axis controller 36 by depressing the grip body 16 to actuate an internal switch 36. The switch 36 may include an internal spring strong enough to resist casual contact with the grip body. Alternatively, an external suspension spring may be employed between the grip body 16 and the stem 14. The switch 36 may include additional components to detect grip body 16 rotation, or yaw, about the z-axis. These additional components may include a rheostat, a Hall effect device with a sensor fixed to the grip body 16 or the stem 14, or a linear magnetic strip with a wiper assembly attached to the grip body 16 and the stem 14.

This yaw rotation corresponding to an adduction or abduction displacement of a user's wrist permits the user to manipulate three-dimensional objects, such as 3-D computer drawings. Rotation of the grip body 16 about the stem axis from a radial and ulnar deviation of the wrist rotates the 3-D drawings about the z-axis. Releasing the grip body 16 from its depressed position disengages the z-axis controller 36. Alternatively, depressing and releasing the grip body 16 can disengage the z-axis controller 36. Alternatively, upon actuation of the z-axis switch 36, rotation of the 3-D drawings may be accomplished with the scroll wheel 30 or another control wheel incorporated into the grip body 16.

As a further alternative embodiment, the grip body 16 may include a control wheel, similar to the scroll controller 30, to provide z-axis inputs. The control wheel may be attached to the side of the grip body 16 where it could be operated by the user's thumb. Depressing the control wheel can activate and deactivate the z-axis control, and rolling the wheel would rotate the selected object about its z-axis. Regardless of the z-axis controller employed, the encoder 24 can provide output signals to the computer or other device.

For the common x- and y-axes, there are several means to detect the motion of the input housing 18, that is, the rotation of the grip body 16 upon the stem 14. In one embodiment, the input detector 20 is a potentiometer. In another embodiment, the input detector 20 is an electromagnetic transducer. In yet another embodiment, the input detector 20 is a differential magnetic device. Whichever device is used, an encoder 24 can receive the signals from it and convert the signals into instructions that can be used by the computer, game, data processor or industrial equipment. The encoder 24 can be a hardwired to the computer or other equipment, or alternatively, the controller 10 can be wireless and include an internal battery.

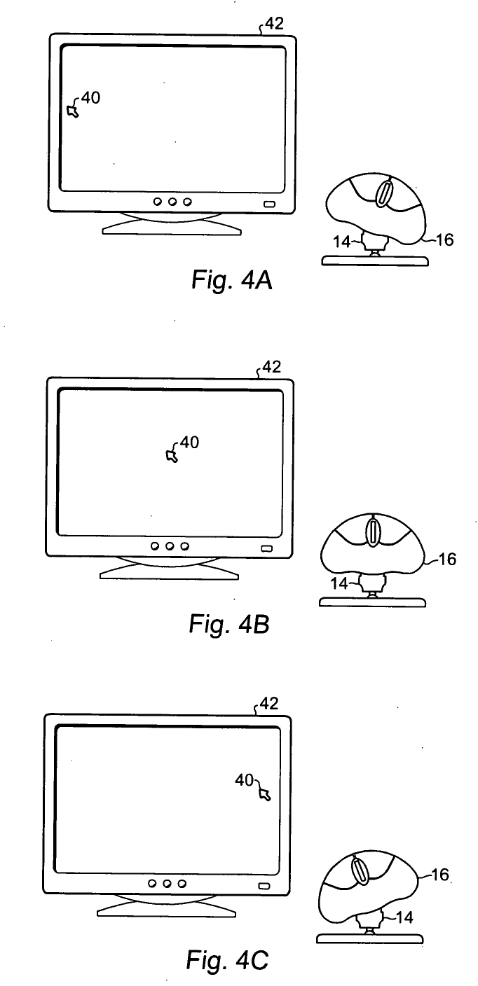

FIGS. 4a-4c show front views of the controller 10 and illustrate the operation of the controller 10 in displacement of a cursor in the x-axis. The motion required to operate the controller 10 in the x-axis, such as to move a computer cursor 40 left and right, is the radial motion of the wrist. Beginning from a pronation orientation, the user radially displaces the controller causing the cursor to be displaced along the x-axis. The motion is akin to turning a doorknob. A slight rolling of the wrist is all that is required to move the cursor 40 from the extreme left to the extreme right of the screen 42. No repositioning is required. The motion is natural and ergonomically correct. FIG. 4a shows the grip body 16 rolled to the left, and the corresponding position of the computer cursor 40. FIG. 4b shows the grip body 16 in a neutral position so that the cursor 40 is at the center of the screen 42. FIG. 4c shows the grip body 16 rolled to the right, and the corresponding position of the computer cursor 40. FIGS. 4a-4c show the stem 14 oriented purely vertical, with no adjustment left or right.

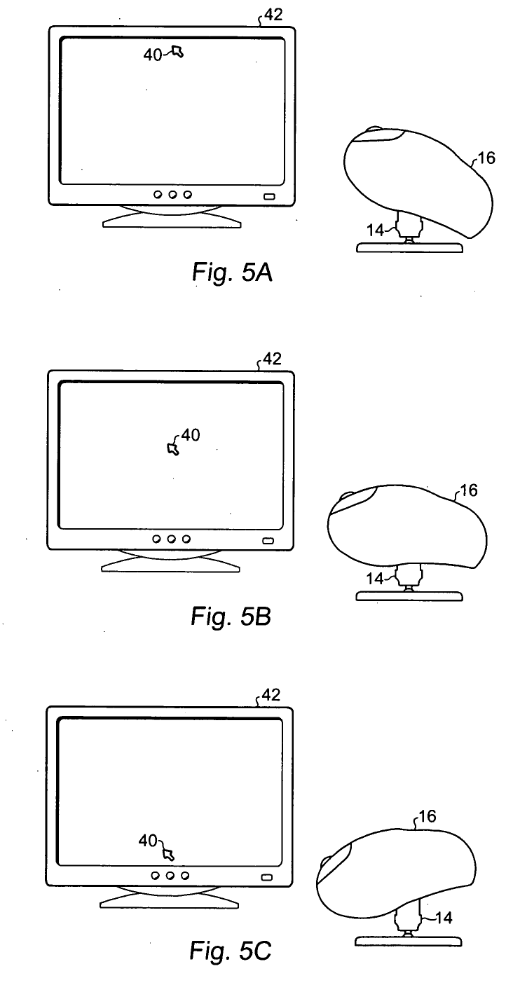

FIGS. 5a-5c show left side views of the controller 10 and illustrate the operation of the controller 10 in the y-axis. The motion required to operate the controller 10 in the y-axis, such as to move a computer cursor 40 up and down, is dorsiflexion and palmarflexion to an extension or flexion state of the wrist respectively. The motion is akin to the rolling of a motorcycle throttle. A slight rolling of the wrist is all that is required to move the cursor 40 from the extreme top to the extreme bottom of the screen 42. No repositioning of the controller or hand is required. The motion is natural, ergonomically correct, and physiologically harmless. FIG. 5a shows the grip body 16 rolled aft, and the corresponding position of the computer cursor 40 at the top of the computer monitor 42. FIG. 5b shows the grip body 16 in a neutral position so that the cursor 40 is at the center of the screen 42. FIG. 5c shows the grip body 16 rolled forward, and the corresponding position of the computer cursor 40 at the bottom of the computer monitor 42. FIGS. 5a-5c show the stem 14 oriented purely vertical, with no adjustment fore or aft. The grip body 16 can be rolled fore and aft and side to side to place the cursor 40 in any desired position on the monitor 42.

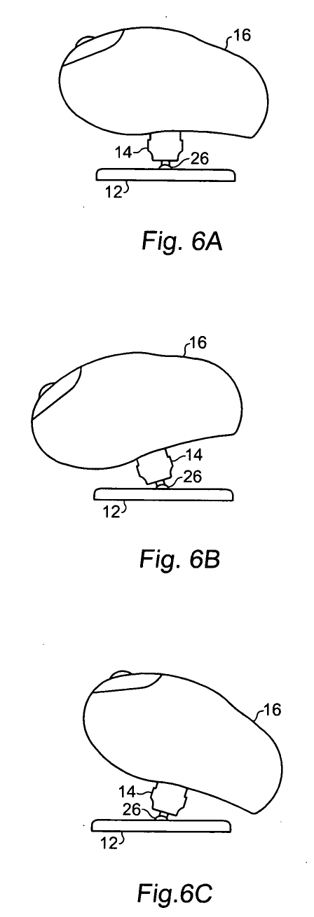

FIGS. 6a-6c show left side views of the controller 10 and illustrate the adjustment of the stem 14 upon the pedestal 12. FIG. 6a shows the stem 14 completely vertical, in a neutral position. FIG. 6b shows the stem 14 tilted forward. FIG. 6c shows the stem 14 tilted aft upon the pedestal.

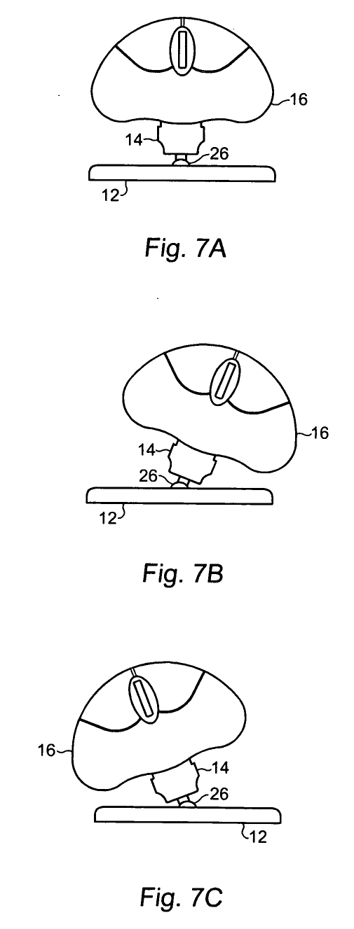

FIGS. 7a-7c show front views of the controller 10 and illustrate the adjustment of the stem 14 upon the pedestal 12. FIG. 7a shows the stem 14 completely vertical, in a neutral position. FIG. 7b shows the stem 14 tilted to the left. FIG. 7c shows the stem 14 tilted to the right. Stem 14 adjustment is desired to move the neutral position of the grip body 16 to correspond with the neutral position of the user's hand. Generally, a right-handed user will want the stem 14 and the neutral point tilted slightly to the right, while left-handed users will want the stem 14 and the neutral point tilted slightly to the left. Fore and aft adjustment of the stem 14 will depend on several factors, including the height of the user's desk and chair.

The height of the stem 14 is also adjusted to compensate for these variables and to provide a comfortable neutral point for the user's hand upon the grip body 16.

In each of FIGS. 6a-6c and 7a-7c, the grip body 16 is shown at the neutral point. This means that even as the stem 14 is tilted, the neutral point of the grip body 16 remains in the same orientation with respect to the stem 14.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An input controller for inputting user commands to a computing device, comprising:
a pedestal in contact with a work surface wherein the work surface defines a x-y plane and wherein the pedestal is displaced from the work surface defining a Z direction;
an input housing rotatably gimbaled atop the pedestal defining a datum plan parallel to the work surface wherein the input housing is capable of simultaneous angular displacement from the datum plane in a Z-Y plane and a Z-X plane and wherein the input housing further comprises at least one sensor capable of detecting angular displacement of the input housing from the datum plane in the Z-Y plane and the Z-X plane;
an input detector communicatively coupled to the input housing and the computing device and configured to receive signals corresponding to angular displacement of the input housing from the datum plane and convert the signals into planer positional commands of the cursor compatible with the computing device; and
a grip body attached to the input housing wherein a full-range angular displacement of the input housing from the datum plane is configurable to correspond to a displayable field of the computing device, the pedestal remaining in substantially the same position on the X-Y plane.

2. The input controller of claim 1, wherein the input housing further comprises a position retaining device configurable to maintain the angular displacement of the input housing upon removal of any displacing force.

3. The input controller of claim 1, wherein the input detector converts the signals into positional commands for the cursor corresponding to a 2 dimensional rendition of 3 dimensional space.

4. The input controller of claim 3, further comprising a z-axis controller incorporated into the grip body.

5. The input controller of claim 1, further comprising a stem adjustably attached between the pedestal and the grip body.

6. The input controller of claim 5, where the stem comprises a threaded adjuster.

7. The input controller of claim 5, further comprising a ball joint between the pedestal and the stem.

8. The input controller of claim 1, where the grip body comprises a plurality of control buttons.

9. The input controller of claim 8, where the grip body further comprises a scroll controller.

10. The input controller of claim 1 wherein a full-range angular displacement of the input housing from the datum plan in the Z-Y plane corresponds to normal dorsiflexion and normal palmarflexion of user's wrist in a full pronation orientation.

11. The input controller of claim 1 wherein a full-range angular displacement of the input housing from the datum plan in the Z-X plane corresponds to normal radial rotation of user's wrist beginning from a full pronation orientation without any adduction or adbuction deviation.

12. An ergonomic mouse, comprising
a pedestal having a generally planar lower surface for contact with a work surface;
an adjustable stem attached atop the pedestal; and
a grip body rotatably attached atop the stem,

13. The ergonomic mouse of claim 12, further comprising a z-axis controller incorporated into the grip body.

14. The ergonomic mouse of claim 13, where the grip body further comprises a plurality of control buttons.

15. The ergonomic mouse of claim 14, where the grip body further comprises a scroll controller.

16. The ergonomic mouse of claim 13, wherein the z-axis controller is a control wheel attached to a side of the grip body.

17. The ergonomic mouse of claim 12, where the stem comprises a threaded adjuster for adjusting the length of the stem.

18. A method for inputting user commands to a computing device, comprising:
coupling an ergonomic input controller to the computing device wherein the ergonomic input controller comprises a pedestal in contact with a work surface and an input housing rotatably gimbaled atop the pedestal defining a datum plan parallel to the work surface
receiving signals at the input housing corresponding to angular displacement of the input housing deviating from the datum plane;
converting the inputs the signals into planer positional commands for a cursor compatible with the computing device; and
communicating planer positional commands from the ergonomic input controller to the computing device.

19. The method of claim 18, further comprising maintaining the angular displacement of the input housing upon removal of any displacing force.

20. The method of claim 19, further comprising limiting angular displacement of the input housing from the datum plan to correspond to normal dorsiflexion, normal palmarflexion, and normal radial rotation of user's wrist from a full promotion orientation without any radial or ulnar deviation.
